(19) United States
(12) Patent Application Publication
(10) Pub. No.: US 2026/0073112 A1
(43) Pub. Date: Mar. 12, 2026

(54) PESSIMISM REDUCTION IN VERY LARGE SCALE INTEGRATED (VLSI) CIRCUIT DESIGN USING NET-SPECIFIC K FACTORS

(71) Applicant: International Business Machines Corporation, Armonk, NY (US)

(72) Inventors: Jason David Morsey, Hopewell Junction, NY (US); Steven Eugene Washburn, Poughquag, NY (US); Adil Bhanji, Wappingers Falls, NY (US); Jack DiLullo, Austin, TX (US)

(21) Appl. No.: 18/827,982

(22) Filed: Sep. 9, 2024

(51) Int. Cl. G06F 30/3323; G06F 119/10; G06F 119/12

(52) U.S. Cl. CPC G06F 30/3323; G06F 2119/10; G06F 2119/12

(57) ABSTRACT

A computer implemented method includes determining a noise adjustment value for a specific subnet of a very large scale integrated (VLSI) circuit. A K factor for the specific subnet is determined based on the noise adjustment value of the specific subnet. The K factor is constant such that a timing of the specific subnet including the K factor is equal to the noise adjustment value of the specific subnet. The K factor for the specific subnet is stored in a design architecture.

### BACKGROUND

The present disclosure relates to a very-large-scale integration (VLSI) circuit design, and more particularly to, a method, a system, and a computer product for determining timing delays caused by coupling between nets.

Hierarchical VLSI circuit designs combine millions or billions of transistors, as well as other circuit components on a single integrated circuit chip to create an overall circuit. The transistors and other electrical components are grouped into sub-networks (alternately referred to as nets), with each net being configured to perform a defined function and having defined inputs and outputs. In some examples, nets can be constructed of further sub-networks, resulting in hierarchies including layers beyond two. Each net can be replicated as needed, interconnected via traces, and placed on the chip to create the top level hierarchical circuit design.

### SUMMARY

Embodiments of the present invention are directed to a computer-implemented method for very large scale integration (VLSI) circuit design. A non-limiting example of the computer-implemented method includes determining a noise adjustment value for a specific subnet of a very large scale integrated (VLSI) circuit. A K factor for the specific subnet is determined based on the noise adjustment value of the specific subnet. The K factor is constant such that a timing of the specific subnet including the K factor is equal to the noise adjustment value of the specific subnet. The K factor for the specific subnet is stored in a design architecture.

Embodiments of the present invention are further directed to a computer program product for distributing the computer implemented method to one or more computer systems.

Additional technical features and benefits are realized through the techniques of the present invention. Embodiments and aspects of the invention are described in detail and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts one exemplary cloud computing system configured to implement the system and method according to one embodiment;

FIG. 2 depicts a simplified exemplary very large scale integrated (VLSI) circuit design;

FIG. 3 depicts a boundary between exemplary networks of the VLSI circuit design of FIG. 2 including schematic details of a second net;

FIG. 4 depicts the boundary between exemplary nets of the VLSI circuit design of FIG. 2 with the second net as a block box circuit;

FIG. 5 depicts an exemplary process for determining a K factor sensitivity of a given net;

FIG. 6 depicts a block diagram of a system to perform the pessimism reduction in circuit design according to embodiments of the invention; and

FIG. 7 depicts a process flow of a method of fabricating the integrated circuit according to exemplary embodiments of the invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Computing environment 100 contains an example of an environment for the execution of at least some of the computer code involved in performing the inventive methods, such as granting a validation ability without user access or login at block 150. In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 132. Public Cloud 105 includes gateway 130, Cloud orchestration module 131, host physical machine set 132, virtual machine set 143, and container set 144.

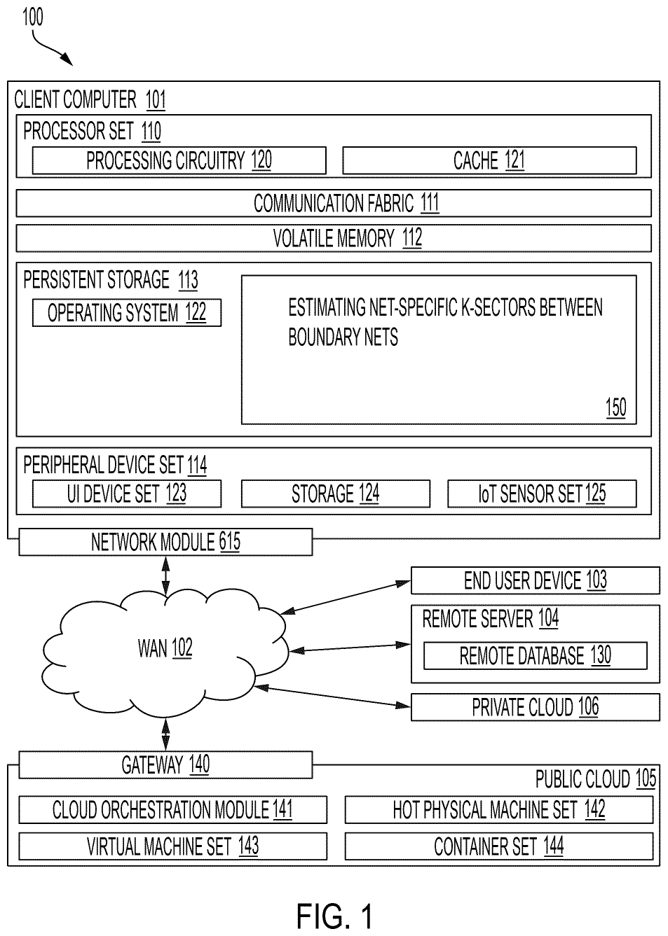

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 131. The computing resources provided by public Cloud 105 are typically implemented by virtual computing environments that run on various computers making up the computers of host physical machine set 132, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Turning now to an overview of technologies that are more specifically relevant to aspects of the invention, in hierarchical VLSI circuit designs, signal noise can be caused by capacitances due to capacitive coupling on boundary connections between nets on a given levels of hierarchy as well as capacitive coupling of traces within a net and operation of the electronics on the net. Exacerbating the impact of signal noise is the fact that a designer designing at a given hierarchical level of the VLSI circuit may not have access to, or be able to easily ascertain, the particular capacitive coupling of traces within each net being used to construct the hierarchical level.

Due the lack of information, assumptions about the nets are made and the assumptions can result in an inaccuracy in the noise analysis. To minimize any potential detriments that may occur due to inaccuracy, the assumptions are made in a pessimistic manner (e.g., assuming worse than expected noise). One of the trade-offs of the pessimistic approach is that the pessimism can overpredict a coupled noise between the nets. This overprediction results in overdesign to compensate for the predicted coupled noise even though the actual coupled noise may be substantially smaller than the predicted noise on the VLSI circuit.

In one example, the compensation is performed by multiplying capacitances on the net by a compensation factor referred to as a K factor and designing with the resultant timing (base timing including the K factor) as a requirement.

Turning now to an overview of the aspects of the invention, one or more embodiments of the invention address the above-described shortcomings of the prior art by providing a process for determining a net specific K factor and storing the net specific K factor for use during a physical design process. Net specific K factors are K factor values determined for specific nets based on the characteristics of that net. In contrast, a general pessimistic approach uses a single worst case K factor with the worst case K factor being applied to all nets regardless of the particular characteristics of the net.

Net specific K factors are applied by determining the timing of the boundary connection and the net and altering that timing based on the K factor. This in turn allows for more realistic and less pessimistic estimations of the noise preventing overdesign and shortening a duration of a design process.

In some examples, the reduced overdesign requirement can further allow for additional efficiencies to be implemented in the physical design stages where such additional efficiencies would have been prevented due to the overdesign requirements of a pessimistic noise estimation.

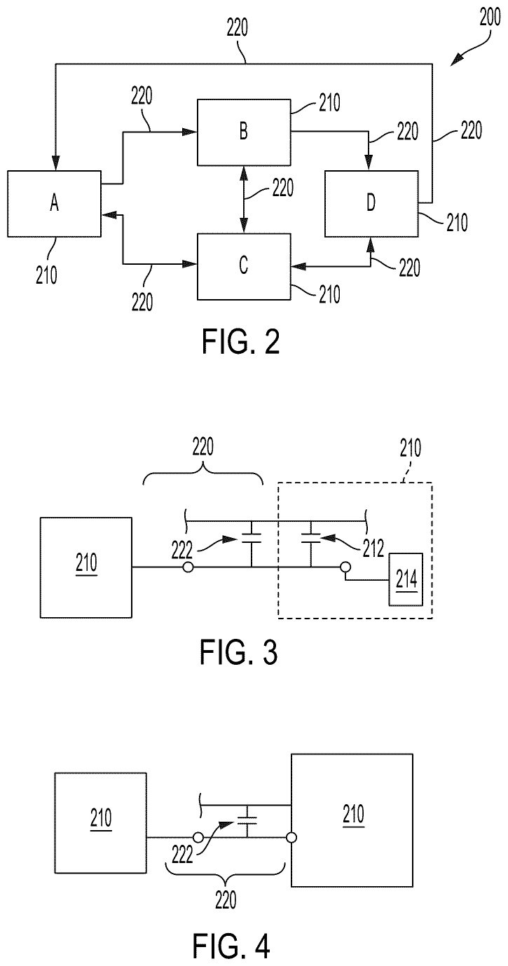

Turning now to a more detailed description of aspects of the present invention, FIG. 2 depicts a circuit 200 at a single hierarchy of a hierarchical VLSI circuit design. The example circuit 200 is substantially simplified for explanatory purposes and includes four subnetworks A, B, C and D (nets 210). Each net 210 is connected to one or more other nets 210 via boundary connections 220. The boundary connections 220 can be one way (indicated via an arrowhead on only one end of the boundary connection 220) or two way (indicated via an arrowhead on each end of the boundary connection 220). While illustrated as individual communication lines, it is appreciated that a practical implementation will utilize a substantial number of circuit traces in a give boundary connection 220 and is not limited to the illustrated single electrical connection. Each net 210 includes internal circuitry to define a function that receives input signals from the boundary connections 220, and outputs resultant signals using the boundary connections 220.

Each net 210 includes its own internal timing as a result of the internal circuitry and internal capacitive coupling within the net 210. The internal timing of the net 210 is the result of, and is dependent on, physical placement of the electronics and traces within the net 210, as well as the internal operations performed by the net 210.

In addition to the internal timing of each net 210, the overall timing of the circuit 200 is designed to account for noise generated due to capacitive linking between adjacent traces and components. This capacitive linking is referred to as coupling capacitances. In prior designs full analysis of a completed circuit was avoided by using a pessimistically estimated multiplier (K factor) applied to the boundary connection timing to determine an overall timing required to overcome the estimated noise. As discussed above, the pessimistic estimation of the multiplier results in overdesign requirements.

In contrast to the prior art design processes, the circuit 200 is designed using a method that identifies the existing slews of a boundary connection 220 to a net 210 in a known configuration, and extrapolates a net 210 specific K factor from the known existing slews. The process generally uses existing slews to compute a noise adjustment (a) for a known boundary connection to a known net 210 in a known physical arrangement. The known physical arrangement includes a source-sink configuration, and an early, late, rise and fall values of the specific net 210

Based on the noise adjustment, a K factor for the specific net 210 being analyzed is computed. The K factor produces the same effect on timing of the boundary connection 220 as the noise adjustment (a) and is stored in a design architecture. The net specific K factor can then be used during physical design any time that specific net 210 is being used.

In some examples, the timing is calculated at two different K factors, and the finite difference between the results is used to calculate a sensitivity of the boundary connection 220 and net 210. The resultant sensitivity is used to determine the K factor which is stored within the design architecture and can be utilized in a physical design step without the noise adjustment (a) for the corresponding net 210 needing to be recalculated for each potential design iteration and without requiring a pessimistic estimation.

The net result of this process is a set of K factors, with each net 210 available in a design architecture having a corresponding K factors within the set. The physical construction of the circuit 200 can then be optimized and designed by applying the corresponding K-values to the net connections 210 for any potential design iteration.

With continued reference to FIG. 2, FIGS. 3 and 4 illustrate a boundary connection 220 between two nets 210, with FIG. 3 illustrating a second net 210 including schematic representation of internal capacitances 212, and components 214 and FIG. 4 illustrating the second net 210 as a black box element. In a first portion of the process, the noise adjust (a) is computed using the full information illustrated in FIG. 3 with the internal capacitive coupling 212, internal components 214, and the boundary net capacitive coupling 222.

In the second portion of the process, the sensitivity to K is computed for coupling capacitances 222 and 212 acting together and the noise adjust (a) is divided by the sensitivity to K to determine a K factor that can be applied to the coupling capacitances 222 and 212, in order to achieve the same value as noise adjust (a).

Thus, the net specific K factor for the second net 210 is a multiplier that, when applied to the timing resulting from the boundary connection capacitive coupling 222 and 212 results in the same value as the value of the noise adjust (a) which results from the combination of the boundary connection capacitive coupling 222, the internal capacitive coupling 212, and the electronics 214 of the net 210.

With continued reference to FIGS. 2-4, FIG. 5 illustrates a process 500 for determining the net 210 specific K factor and further accounting for a timing sensitivity of the net 210 to changes in the K factor. Initially, a background noise value is set to 0 noise by setting the K value at 1.0 in a Set K=1 step 510.

After setting the noise from coupled capacitances to 0, a complete timing of the circuit, including the internal circuit elements of the net 210, and the timing of the boundary connections 220, is determined via a simulation in an analyze complete timing step 520.

The timing delays occurring during step 520 are saved in a cache file in a cache actual delays step 530. The timing represents the expected actual timing of the circuit in a hypothetical environment where there are no coupled capacitances (e.g., a circuit where there are no adjacent traces, boundary connections 220, or nets 210).

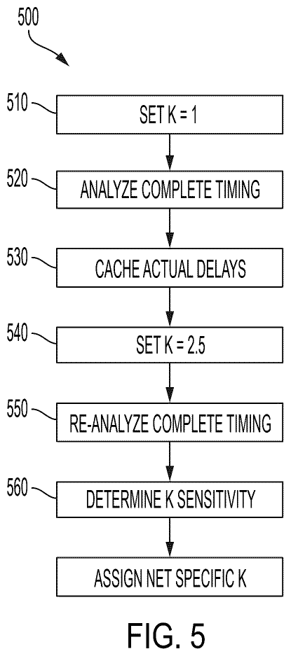

After determining the expected actual timing of the circuit, the process 500 sets a second K factor to simulate the presence of coupled capacitances. In the example of FIG. 5, the K value is set to 2.5 in a set K value to 2.5 step 540. The K value other than 1 indicates a presence of coupled capacitance noise and can be any arbitrary number.

After setting the K value to 2.5, the process 500 reanalyzes the complete timing in a reanalyze complete timing step 550 and stores the resultant timing. The resultant timing is then compared to the cached actual delays and the magnitude of the difference is used to determine the sensitivity to capacitive coupling of the particular net 210 being tested in a determine K factor sensitivity step 560. Based on the sensitivity to capacitive coupling, a net specific K factor is associated with the net 210 and stored in a memory for the later design process. For a given noise adjust (a), The net specific K factor is lower when the net 210 is more sensitive to capacitive coupling and is higher when the net 210 is less sensitive to capacitive coupling.

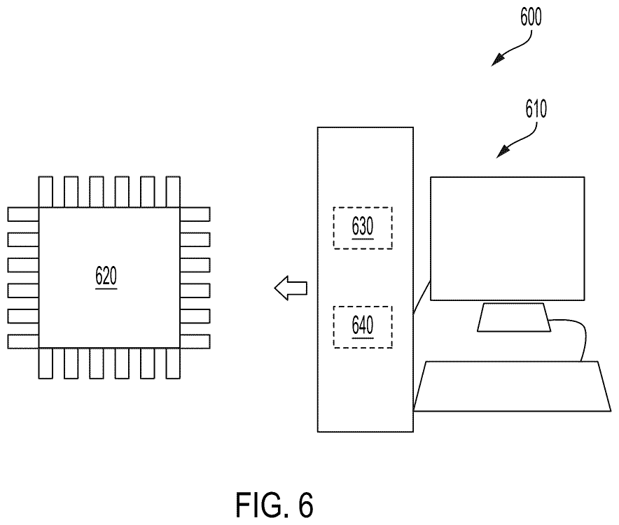

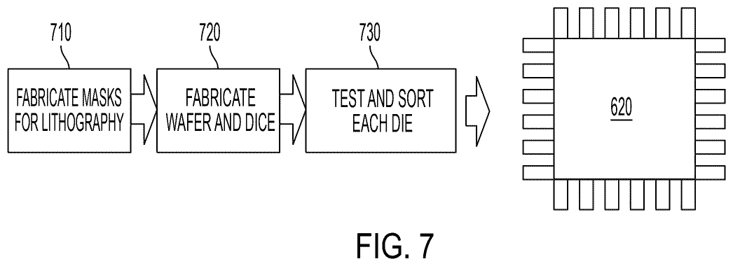

FIG. 6 is a block diagram of a system 600 to perform the process of automatically or semi-automatically inserting power supply rails, fences, and level translators according to embodiments of the invention. The system 600 includes processing circuitry 610 used to generate the design that is ultimately fabricated into an integrated circuit 620. The steps involved in the fabrication of the integrated circuit 620 are well-known and briefly described herein. Once the physical layout is finalized, based, in part, on the placement of the power supply rails, fences, and level translators according to embodiments of the invention to facilitate optimization of the routing plan, the finalized physical layout is provided to a foundry. Masks are generated for each layer of the integrated circuit based on the finalized physical layout. Then, the wafer is processed in the sequence of the mask order. The processing includes photolithography and etch. This is further discussed with reference to FIG. 7.

FIG. 7 is a process flow of a method of fabricating the integrated circuit according to exemplary embodiments of the invention. Once the physical design data is obtained, based, in part, on the automatically or semi-automatically inserting power supply rails, fences, and level translators, the integrated circuit 620 can be fabricated according to known processes that are generally described with reference to FIG. 7. Generally, a wafer with multiple copies of the final design is fabricated and cut (i.e., diced) such that each die is one copy of the integrated circuit 620. At block 710, the processes include fabricating masks for lithography based on the finalized physical layout. At block 720, fabricating the wafer includes using the masks to perform photolithography and etching. Once the wafer is diced, testing and sorting each die is performed, at block 730, to filter out any faulty die.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer implemented method comprising:
determining a noise adjustment value for a specific subnet of a very large scale integrated (VLSI) circuit;
determining a K factor for the specific subnet based on the noise adjustment value of the specific subnet, wherein the K factor is constant such that a timing of the specific subnet including the K factor is equal to the noise adjustment value of the specific subnet; and
storing the K factor for the specific subnet in a design architecture.

2. The computer implemented method of claim 1, wherein determining the K factor for the specific subnet based on the noise adjustment value includes determining a K factor sensitivity of the specific subnet by computing a timing of the specific subnet at a first K factor, computing the timing of the specific subnet at a second K factor, and determining an impact of the K factor on the timing.

3. The computer implemented method of claim 2, wherein determining an impact of the K factor on the timing includes obtaining a finite difference between the timing at the first K factor and the timing of the second K factor.

4. The computer implemented method of claim 2, further comprising determining a noise impact on timing of the specific subnet based on the impact of the K factor on the timing.

5. The computer implemented method of claim 1, wherein storing the K factor for the specific subnet in the design architecture comprises adding the K factor to a set of net specific K factors, wherein each K factor in the set of net specific K factors applies to a distinct K specific subnet.

6. The computer implemented method of claim 1, wherein determining the noise adjustment value for the specific subnet of a very large scale integrated (VLSI) circuit and determining the K factor for the specific subnet based on the noise adjustment value of the specific subnet are performed for a specific configuration of the specific subnet, and wherein the determined K factor is applied to all configurations of the specific subnet by the design architecture.

7. The computer implemented method of claim 1, wherein determining the noise adjustment value for the specific subnet of a very large scale integrated (VLSI) circuit includes determining the noise adjustment value including a source-sink, early, late, rise and fall value of the specific subnet.

8. A computer system comprising:
a computer having a processor set and a persistent storage memory, wherein the persistent storage memory stores instructions for causing the processor set to:
determine a noise adjustment value for a specific subnet of a very large scale integrated (VLSI) circuit;
determine a K factor for the specific subnet based on the noise adjustment value of the specific subnet, wherein the K factor is constant such that a timing of the specific subnet including the K factor is equal to the noise adjustment value of the specific subnet; and
store the K factor for the specific subnet in a design architecture.

9. The computer system of claim 8, wherein determining the K factor for the specific subnet based on the noise adjustment value includes determining a K factor sensitivity of the specific subnet by computing a timing of the specific subnet at a first K factor, computing the timing of the specific subnet at a second K factor, and determining an impact of the K factor on the timing.

10. The computer system of claim 9, wherein determining an impact of the K factor on the timing includes obtaining a finite difference between the timing at the first K factor and the timing of the second K factor.

11. The computer system of claim 9, further comprising determining a noise impact on timing of the specific subnet based on the impact of the K factor on the timing.

12. The computer system of claim 8, wherein storing the K factor for the specific subnet in the design architecture comprises adding the K factor to a set of net specific K factors, wherein each K factor in the set of net specific K factors applies to a distinct K specific subnet.

13. The computer of claim 8, wherein determining the noise adjustment value for the specific subnet of a very large scale integrated (VLSI) circuit and determining the K factor for the specific subnet based on the noise adjustment value of the specific subnet are performed for a specific configuration of the specific subnet, and wherein the determined K factor is applied to all configurations of the specific subnet by the design architecture.

14. The computer system of claim 8, wherein determining the noise adjustment value for the specific subnet of a very large scale integrated (VLSI) circuit includes determining the noise adjustment value including a source-sink, early, late, rise and fall value of the specific subnet.

15. A computer program product storing instructions for causing a computer system to determine a noise adjustment value for a specific subnet of a very large scale integrated (VLSI) circuit, determine a K factor for the specific subnet based on the noise adjustment value of the specific subnet, wherein the K factor is constant such that a timing of the specific subnet including the K factor is equal to the noise adjustment value of the specific subnet, and to store the K factor for the specific subnet in a design architecture.

16. The computer program product of claim 15, wherein determining the K factor for the specific subnet based on the noise adjustment value includes determining a K factor sensitivity of the specific subnet by computing a timing of the specific subnet at a first K factor, computing the timing of the specific subnet at a second K factor, and determining an impact of the K factor on the timing.

17. The computer program product of claim 16, wherein determining an impact of the K factor on the timing includes obtaining a finite difference between the timing at the first K factor and the timing of the second K factor.

18. The computer program product of claim 15, wherein storing the K factor for the specific subnet in the design architecture comprises adding the K factor to a set of net specific K factors, wherein each K factor in the set of net specific K factors applies to a distinct K specific subnet.

19. The computer program product of claim 15, wherein determining the noise adjustment value for the specific subnet of a very large scale integrated (VLSI) circuit and determining the K factor for the specific subnet based on the noise adjustment value of the specific subnet are performed for a specific configuration of the specific subnet, and wherein the determined K factor is applied to all configurations of the specific subnet by the design architecture.

20. The computer program product of claim 15, wherein determining the noise adjustment value for the specific subnet of a very large scale integrated (VLSI) circuit includes determining the noise adjustment value including a source-sink, early, late, rise and fall value of the specific subnet.
